(19) United States
(12) Patent Application Publication
(10) Pub. No.: US 2010/0091140 A1
(43) Pub. Date: Apr. 15, 2010

(54) ELECTRONIC DEVICE AND METHOD FOR CAPTURING SELF PORTRAIT IMAGES

(75) Inventor: HUNG-LUN PAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/512,219

(22) Filed: Jul. 30, 2009

(30) Foreign Application Priority Data
Oct. 10, 2008 (CN) 200810304872.1

(51) Int. Cl. H04N 5/76; H04M 1/00; G06K 9/00

(52) U.S. Cl. 348/231.99; 455/556.1; 382/118; 348/E05.031

(57) ABSTRACT

A method for capturing self portrait images controls a camera of an electronic device to capture a temporary self portrait image of a user. A face of the user in the temporary self portrait image is identified. If the face lies outside a designated image region, the camera is adjusted, and a next image is captured. If the face lies within the designated image region, the temporary self portrait image is stored as a captured self portrait image.

### BACKGROUND

1. Technical Field

Embodiments of the present disclosure relate to capturing images, and particularly to an electronic device and method for capturing self portrait images.

2. Description of Related Art

Nowadays, many mobile phones are able to capture images. A camera lens is usually installed at the back of a mobile phone while a display screen is installed at the front of the mobile phone. When capturing a regular image, a user views the display screen to compose the image. When capturing a self portrait image, the display screen is not viewable. Therefore, a face of the user in the self portrait image may lie outside a desired image region.

### BRIEF DESCRIPTION OF THE DRAWINGS

FIG. 1 is a block diagram of one embodiment of an electronic device for capturing self portrait images.

FIG. 2 is a flowchart of one embodiment of a method for capturing self portrait images.

FIG. 3 illustrates one embodiment of an image region.

FIG. 4 illustrates one embodiment of facial features.

FIG. 5 illustrates another embodiment of facial features.

### DETAILED DESCRIPTION

All of the processes described below may be embodied in, and fully automated via, functional code modules executed by one or more general purpose processors of an electronic device. The code modules may be stored in any type of storage medium. Some or all of the methods may alternatively be embodied in specialized hardware.

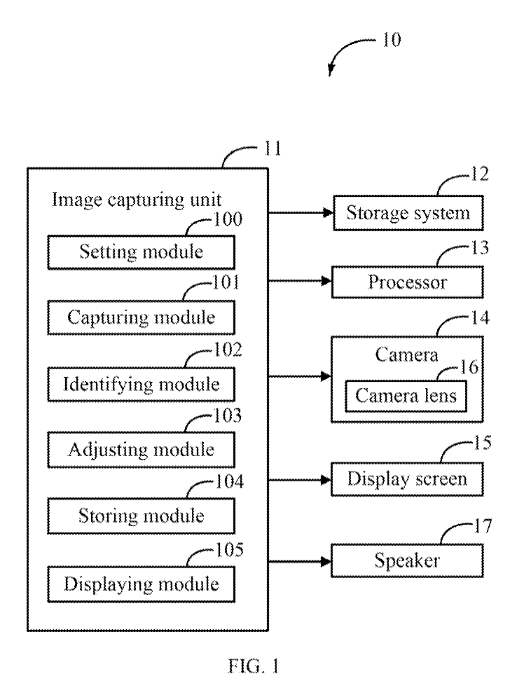

FIG. 1 is a block diagram of one embodiment of an electronic device 10 for capturing self portrait images. The electronic device 10 is able to capture a self portrait image aligned in a designated image region.

The electronic device 10 may be a mobile phone or a personal digital assistant (PDA). In one embodiment, the electronic device 10 may include an image capturing unit 11, a storage system 12, a processor 13, and a camera 14. In another embodiment, the electronic device 10 may further include a display screen 15 and a speaker 17. One or more computerized codes of the image capturing unit 11 is stored in the storage system 12 and executed by the processor 13. The storage system 12 may include an internal memory and an external memory. The external memory may include a smart media card (SMC), a secure digital card (SDC), a compact flash card (CFC), a multi media card (MMC), a memory system stick (MS), an extreme digital card (XDC), and a trans flash card (TFC).

The electronic device 10 may be supported on a tripod to capture a self portrait image. The camera lens 16 may be installed at the back of the electronic device 10. The display screen 15 may be installed at the front of the electronic device 10. When capturing a self portrait image with the electronic device 10, the display screen 15 would not be viewable.

In one embodiment, the image capturing unit 11 may include a setting module 100, a capturing module 101, an identifying module 102, an adjusting module 103, a storing module 104, and a displaying module 105.

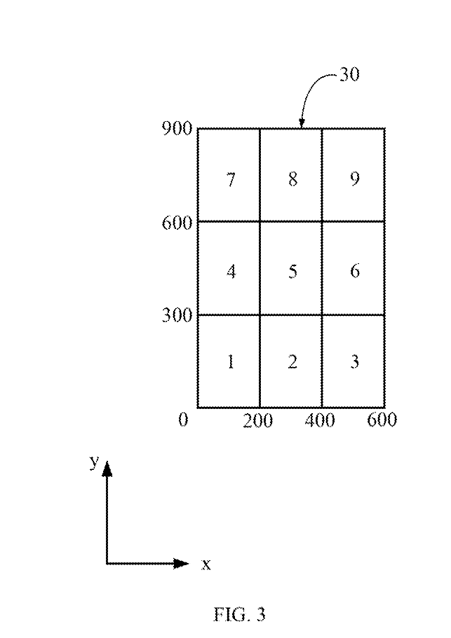

The setting module 100 is operable to set an image size and an image region of self portrait images. It may be understood that an image size of an image is a measure of the number of pixels along width and height of the image. In one embodiment with respect to FIG. 3, a rectangle 30 may denote a self portrait image captured by the camera 14. The self portrait image is 600 pixels wide and 900 pixels high. Each pixel may be characterized by an x-coordinate and a y-coordinate. It may also be understood that an image region of an image is a range of the image. The rectangle 30 is divided into sections “1,” “2,” “3,” “4,” “5,” “6,” “7,” “8,” and “9.” Each of the sections is 200 pixels wide and 300 pixels high. A section, such as the section “5,” may be set as the image region.

The capturing module 101 is operable to control the camera 14 to capture a temporary self portrait image of a user. In one example, the electronic device 10 may be held by the user, along with the camera lens 16 trained on the user. In this case, the display screen 15 isn't viewable to the user.

The identifying module 102 is operable to identify a face of the user in the temporary self portrait image, and determine if the face lies within the image region. In one embodiment, the identifying module 102 extracts facial features from the temporary self portrait image. The facial features may be eyes, mouth, and mouth. If the facial features lie within the image region, the identifying module 102 may determine that the face lied within the image region. Otherwise, if the facial features are not within the image region, the identifying module 102 may determine that the face of the user lies outside the image region.

The adjusting module 103 is operable to adjust the camera if the face of the user lies outside the image region. In one embodiment, the adjusting module 103 may adjust a horizontal angle or a vertical angle of the camera lens 16.

The storing module 104 is operable to store the temporary self portrait image into the storage system 12 as a captured self portrait image if the face of the user lies within the image region.

The displaying module 105 is operable to display the captured self portrait image on the display screen 15.

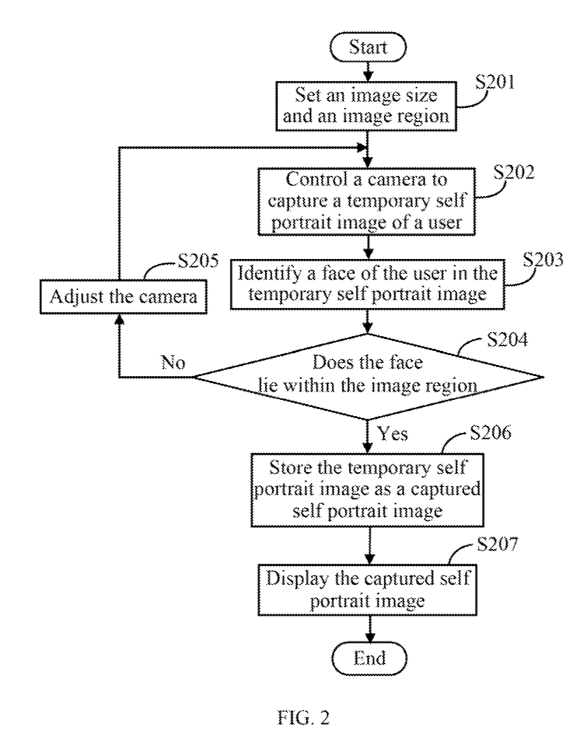

FIG. 2 is a flowchart of one embodiment of a method for capturing self portrait images in the electronic device 10 of FIG. 1. The method may obtain a self portrait image aligned in a designated image region. Depending on the embodiments, additional blocks may be added, others removed, and the ordering of the blocks may be changed.

In block S201, the setting module 100 sets an image size and an image region of self portrait images. FIG. 3 illustrates one embodiment of the image region. The image size of self portrait images may be 600×900 pixels. A rectangle 30 denotes a self portrait image captured by the camera 14. As mentioned above, the rectangle 30 may be divided into various sections. A section, such as the section “5,” may be set as the image region. Depending on the embodiment, any other area of the rectangle 30, such as an area consisting of the sections “5,” “6,” “8,” and “9” may be set as the image region.

In block S202, the capturing module 101 controls the camera 14 to capture a temporary self portrait image of a user. The user may be in a first position facing the camera lens 16 of the camera 14. The temporary self portrait image may be as large as the image size, such as 600×900 pixels.

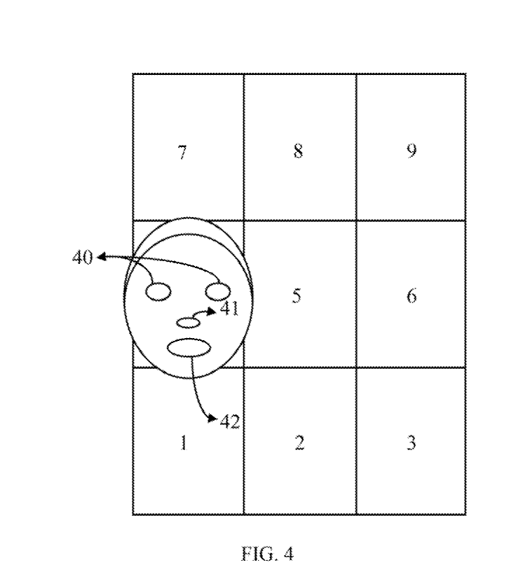

In block S203, the identifying module 102 identifies a face of the user in the temporary self portrait image. In one embodiment, the identifying module 101 may extract facial features, such as eyes, nose, and mouth, from the temporary self portrait image. In one example with respect to FIG. 4, eyes 40, nose 41, and mouth 42 are extracted from the temporary self portrait image. The extracted facial features may be used to determine the face of the user in the temporary self portrait image.

In block S204, the identifying module 102 determines if the face of the user lies within the image region. The identifying module 101 may determine if the face of the user lies within the image region according to the extracted facial features. In one example, the identifying module 102 determines that the face of the user lies within the image region if the extracted facial features lies within the image region. The face of the user may lie outside the image region if any of the extracted facial features lies outside the image region. In one example as shown in FIG. 4, the eyes 40, the nose 41, and the mouth 42 of the user lie in the section “4.” The section “5” is set as the image region. Therefore, the face of the user lies outside the image region.

If the face lies outside the image region, in block S205, the adjusting module 103 adjusts the camera lens 16, and the process returns to block S202. In one embodiment, the adjusting module 103 may adjust a horizontal angle or a vertical angle of the camera lens 16. In another embodiment, the adjusting module 103 may notify the user to change to a second position via the speaker 17. The second position may be different from the first position.

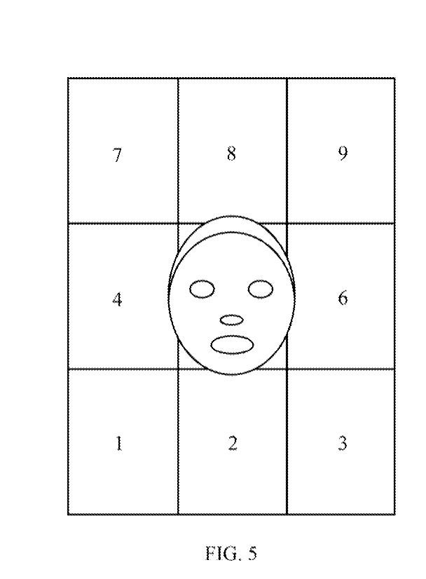

Otherwise, if the face lies within the image region, in block 206, the storing module 104 stores the temporary self portrait image into the storage system 12 as a captured self portrait image. In one example as shown in FIG. 5, the eyes, the nose, and the mouth of the user lie in the section “5.” The section “5” is set as the image region. Therefore, the face of the user lies outside the image region.

In block S207, the displaying module 104 displays the captured self portrait image on the display screen 15.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor; and
an image capturing unit stored in the storage system and being executable by the at least one processor, the image capturing unit comprising:
a setting module to set an image size and an image region of self portrait images;
a capturing module to control a camera of the electronic device to capture a temporary self portrait image of a user;
an identifying module to identify a face of the user in the temporary self portrait image, and determine if the face lies within the image region;
an adjusting module to adjust the camera upon condition that the face lies outside the image region; and
a storing module to store the temporary self portrait image into the storage system as a captured self portrait image upon condition that the face lies within the image region.

2. The electronic device of claim 1, wherein the image capturing unit further comprises a displaying module to display the captured self portrait image on a display screen of the electronic device.

3. The electronic device of claim 1, wherein the identifying module identifies the face of the user in the temporary self portrait image by extracting facial features from the temporary self portrait image.

4. The electronic device of claim 3, wherein the facial features comprise eyes, nose, and mouth.

5. The electronic device of claim 1, wherein the electronic device is a mobile phone or a personal digital assistant (PDA).

6. The electronic device of claim 1, wherein the storage system is selected from the group consisting of a smart media card (SMC), a secure digital card (SDC), a compact flash card (CFC), a multi media card (MMC), a memory system stick (MS), an extreme digital card (XDC), and a trans flash card (TFC).

7. A method for capturing self portrait images in an electronic device, the method comprising:
setting an image size and an image region of self portrait image;
controlling a camera of the electronic device to capture a temporary self portrait image of a user;
identifying a face of the user in the temporary self portrait images;
determining if the face lies within the image region; and
adjusting the camera upon condition that the face lies outside the image region, and controlling the camera of the electronic device to capture a next image; or
storing the temporary self portrait image into a storage system of the electronic device as a captured self portrait image upon condition that the face lies within the image region.

8. The method of claim 7, further comprising:
displaying the captured self portrait image on a display screen of the electronic device.

9. The method of claim 7, wherein the face of the user in the temporary self portrait image is identified by extracting facial features from the temporary self portrait image.

10. The method of claim 9, wherein the facial features comprise eyes, nose, and mouth.

11. The method of claim 7, wherein the electronic device is a mobile phone or a personal digital assistant (PDA).

12. The method of claim 7, wherein the storage system is selected from the group consisting of a smart media card (SMC), a secure digital card (SDC), a compact flash card (CFC), a multi media card (MMC), a memory system stick (MS), an extreme digital card (XDC), and a trans flash card (TFC).

13. A storage medium having stored thereon instructions that, when executed by an electronic device, cause the electronic device to execute a method for capturing self portrait images, the method comprising:
setting an image size and an image region of self portrait images;
controlling a camera of the electronic device to capture a temporary self portrait image of a user;
identifying a face of the user in the temporary self portrait image;
determining if the face lies within the image region;
adjusting the camera upon condition that the facial location lies outside the image region, and controlling the camera of the electronic device to capture a next image;
storing the temporary self portrait image into a storage system of the electronic device as a captured self portrait image upon condition that the face lies within the image region.

14. The storage medium of claim 13, wherein the method further comprises:
displaying the captured self portrait image on a display screen of the electronic device.

15. The storage medium of claim 13, wherein the face of the user in the temporary self portrait image is identified by extracting facial features from the temporary self portrait image.

16. The storage medium of claim 15, wherein the facial features comprise eyes, nose, and mouth.

17. The storage medium of claim 13, wherein the electronic device is a mobile phone or a personal digital assistant (PDA).

18. The storage medium of claim 13, wherein the storage system is selected from the group consisting of a smart media card (SMC), a secure digital card (SDC), a compact flash card (CFC), a multi media card (MMC), a memory system stick (MS), an extreme digital card (XDC), and a trans flash card (TFC).
